(19) United States
(12) Patent Application Publication
(10) Pub. No.: US 2013/0331109 A1
(43) Pub. Date: Dec. 12, 2013

(54) Cell Cluster Network Performance Optimizations

(71) Applicant: T-Mobile USA, Inc., Bellevue, WA (US)

(72) Inventors: Jagjit Dhillon, Hackettstown, NJ (US); Monserrat Dominguez Martinez, Beacon, NY (US); Costel Dragomir, Jersey City, NJ (US); Sivakumar Periyasamy, Parsippany, NJ (US); Stankic Dragan, Morris Plains, NJ (US); Ahmet Ozturk, Denville, NJ (US); Cristina Maria Moldoveanu, Landing, NJ (US)

(21) Appl. No.: 13/913,200

(22) Filed: Jun. 7, 2013

Related U.S. Application Data
(60) Provisional application No. 61/657,603, filed on Jun. 8, 2012.

(51) Int. Cl. H04W 24/02

(52) U.S. Cl. CPC H04W 24/02
USPC 455/446

(57) ABSTRACT

The techniques and systems described herein are directed, in part, to optimizing network performance by repeatedly clustering cell sites of the network and optimizing each cluster of cell sites, thereby optimizing performance of a network as a whole. The cell sites may be base stations, radio access networks, and/or other hardware that directly or indirectly exchanges communications with user devices such as mobile telecommunication devices (e.g., user handsets, user hardware, etc.). By optimizing the clusters of cell sites, a service provider (e.g., a telecommunications company, etc.) may improve network performance in less time and/or with less capital resources than attempting to optimize each cell site on an individual basis.

### RELATED APPLICATIONS

This application claims priority to U.S. provisional patent application Ser. No. 61/657,603, which is entitled “Cell Cluster Network Performance Optimizations” and was filed one Jun. 8, 2012. Provisional patent application Ser. No. 61/657,603 is incorporated herein by this reference in its entirety.

### BACKGROUND

Modern telecommunications networks are complex systems that deploy large amounts of hardware that is controlled with sophisticated software. Thousands of people rely on these telecommunications networks to allow voice communications and access to data from almost any location. Large scale telecommunications networks often include thousands of cell sites (e.g., base stations), which are used to service mobile devices across large areas.

To effectively manage these telecommunications networks, administrators must track many performance metrics for each cell site. Often, administrators perform troubleshooting tasks when a particular cell site is not operating correctly, and thus perform reactive maintenance. The cell sites are typically configured using a network-wide optimization that configures each cell site using the same parameters. Although individual cell site optimization is possible, this solution is costly, time consuming, and can drain capital resources even when the optimization includes automation.

Often, a company such as a telecommunications provider has limited capital resources, such as skilled engineers that can effectively manage each individual cell site to optimize that site. Thus, companies must attempt to effectively use their capital resources to improve services while refraining from overextending their capital resources. Ultimately, these companies must balance providing a high quality service with opposing factors such as operating budgets, which limit capital resources available to the companies.

### DESCRIPTION OF DRAWINGS

Non-limiting and non-exhaustive examples are described with reference to the following figures. In the figures, the left-most digit(s) of a reference number identifies the Fig. in which the reference number first appears. The use of the same reference numbers in different figures indicates similar or identical items or features.

FIG. 1 is a schematic diagram of an illustrative telecommunications environment that may deploy network performance optimizations using cell site clusters.

FIG. 2 is a block diagram of an illustrative controller to manage network performance optimizations using cell site clusters.

FIG. 3 is a schematic diagram of a computing architecture to provide an automated clustering of the cell sites for optimization of a network.

FIG. 4 is a flow diagram of an illustrative process to assign cell sites to clusters using parameters and then optimize some parameters to create an optimized network.

FIG. 5 is a flow diagram of an illustrative process to assign cell sites to clusters using an iterative approach using parameters and then optimize some parameters to create an optimized network.

FIG. 6 is a flow diagram of an illustrative process to create one or more clusters and at least one parameter to optimize each cluster.

FIG. 7 is schematic diagram showing an iterative process to customize parameter changes for various clusters to optimize network performance.

### DETAILED DESCRIPTION

### Overview

The techniques and systems described herein are directed, in part, to optimizing network performance by clustering cell sites (e.g., base stations, etc.) of the network and then optimizing each cluster of cell sites, thereby optimizing performance of a network as a whole. The cell sites may be base stations, radio access networks, and/or other hardware that directly or indirectly exchanges communications with user devices such as mobile telecommunication devices (e.g., user handsets, user hardware, etc.). By optimizing the clusters of cell sites, a service provider (e.g., a telecommunications company, etc.) may improve network performance in less time and/or with less capital resources than attempting to optimize each cell site on an individual basis. In addition, the optimization of the clusters may provide significant service improvements (e.g., fewer dropped calls, more available bandwidth, etc.) than an optimization that is applied across the entire network or an optimization that is based on geographic locations (e.g., optimizing cell sites for a city, a rural area, etc.).

The techniques and systems described herein may be implemented in a number of ways. Example implementations are provided below with reference to the following figures.

### Illustrative Environment

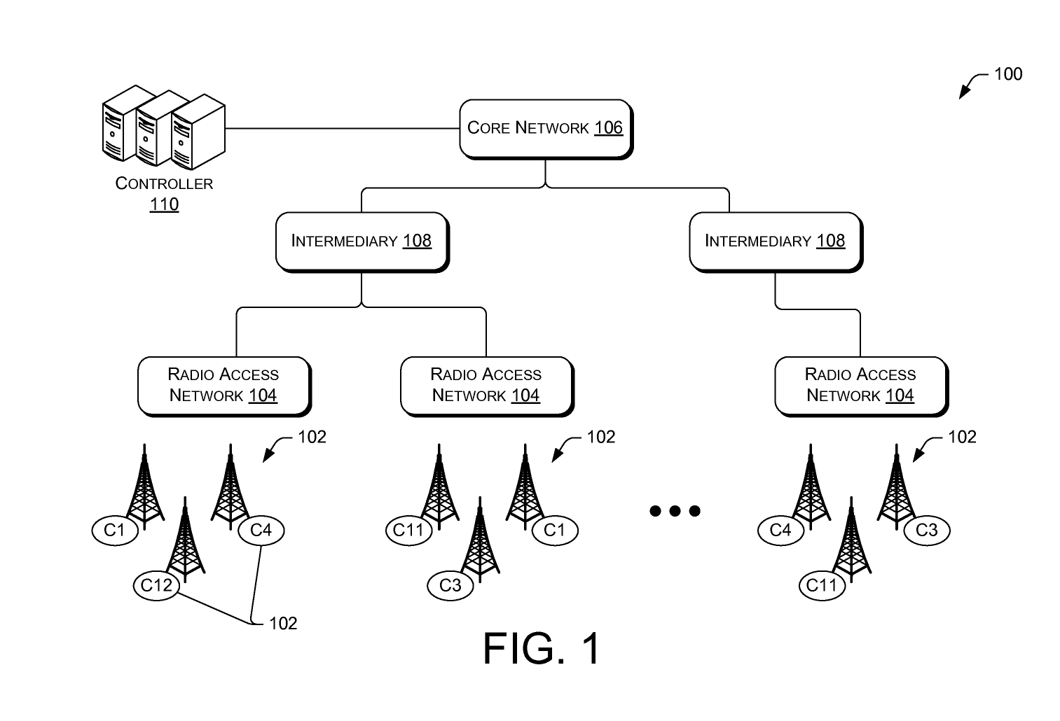

FIG. 1 is a schematic diagram of an illustrative telecommunications network 100 that may deploy network performance optimizations using cell site clusters. The telecommunications network 100 may include a plurality of hardware, software, and other infrastructure. The telecommunications network 100 may include cell sites 102 that are associated with a radio access network (RAN) 104 used for mobile communications. The cell sites 102 may be located across a geographic area to facilitate providing network access and connectivity to users in the geographic area. The cell sites 102 may be base stations, or other network end points (or possibly intermediary points) that exchange communications with user devices, such as mobile telecommunication devices, computing devices, or other devices that have wireless connectivity. The RANs 104 may be in communication with a core network 106 directly or through one or more intermediaries 108, depending on the size and complexity of the telecommunications network 100.

In accordance with one or more embodiments, the telecommunications network 100 may conform to Universal Mobile Telecommunications System (UMTS) technologies that employ UMTS Terrestrial Radio Access Network (UTRAN). In some instances, the UTRAN may share a several components like a Circuit Switch (CS) and a Packet Switch (PS) core network with a GSM EDGE Radio Access Network (GERAN) (Global System for Mobile Communications (GSM), Enhanced Data rates for GSM Evolution (EDGE)). In various instances, long term evolution (LTE) networks may be employed to transmit data for the telecommunications networks besides UMTS. Thus, UTRAN and GERAN networks (and other possible RANs) may coexist to process telecommunications traffic.

In some instances, communications may be handed off between UTRAN and GERAN networks (or other networks) and still maintain a communication with a common core network, such as when a mobile device leaves a range of access (zone) of a UTRAN and enters a range of access of a GERAN. Handoffs may also occur between different types of hardware (e.g. different manufacturers, versions, etc.) for a same network type (e.g., UTRAN, GERAN, etc.).

In accordance with one or more embodiments, other types of networks, RANs, and/or components (hardware and/or software) may be employed which enable telecommunications devices to communicate with the core network 106 to facilitate activities such as voice calling, messaging, emailing, accessing the Internet, or other types of data communications. For example, the telecommunications network 100 may be, at least in part, a Wi-Fi based network, a Bluetooth network, or other type of wireless network.

In some embodiments, the telecommunications network 100 may include a controller 110 to manage network performance optimizations using cell site clusters 112. The controller 110 may be in communication with one or more of the various components of the telecommunications network 100, such as the core network 106, the intermediaries 108, the RANs 104, and/or the cell sites 102. The controller 110 may identify parameters associated with the various cell sites and then create the cell cite clusters 112 of cell sites based at least in part on the parameters. As shown in FIG. 1, the clusters 112 are represented by a designation, such as C1, C2, . . . , Cn (although other designations may be used). Cell sites that include the same designation may belong to a same one of the clusters 112. For example, the illustrative cell sites shown in FIG. 1 include two cell sites designated in cluster 1 (C1), and so forth. The parameters, formation of the clusters 112, and other operations of the controller 110 are explained in further detail in the following figures.

### Illustrative Computing Architecture

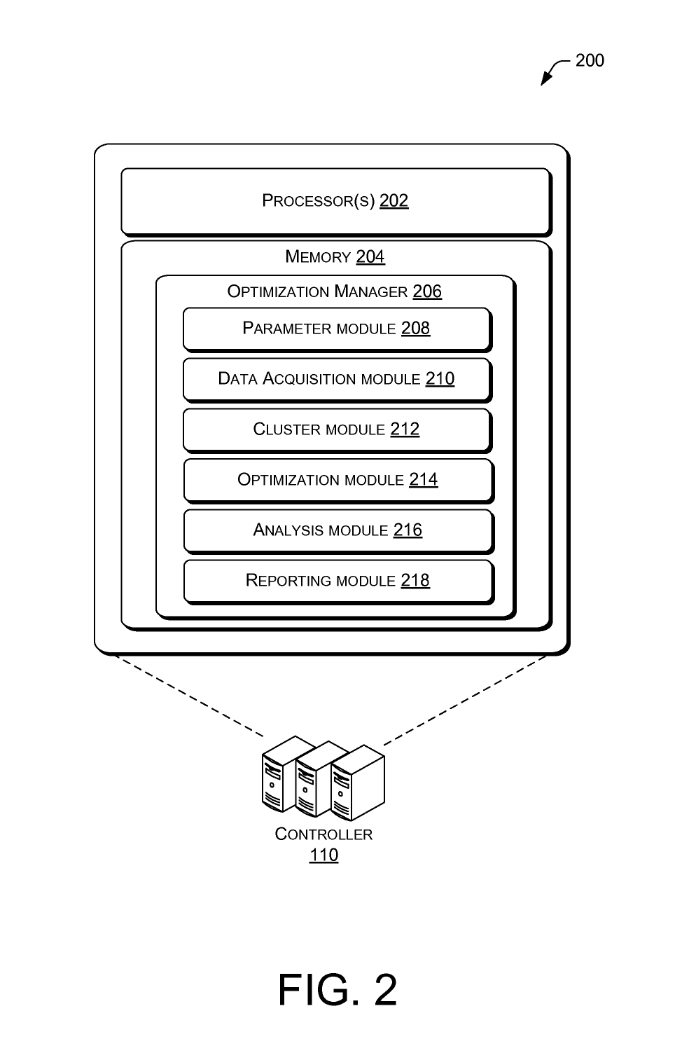

FIG. 2 is a block diagram of an illustrative controller 200 to manage network performance optimizations using cell site clusters. The controller 200 (e.g., the controller 110) may include various modules that perform the functions to create and define the clusters 112, add or assign cell sites to the clusters, and then perform optimizations to the cell sites 102 of each cluster to optimize network performance. The controller 200 may be hosted by one or more servers in a non-distributed configuration (e.g., server farm, etc.) or a distributed configuration (e.g., cloud service, etc.).

The controller 200 may include one or more processors 202 and memory 204 that stores various modules, applications, programs, or other data. The memory 204 may include instructions that, when executed by the one or more processors 202, cause the processors to perform the operations described herein for the controller 200 (e.g., the controller 110). The memory 204 may include, but is not limited to, non-transitory memory that may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. In some embodiments, the memory 204 may include transitory signals, such as signals that a computer system or machine hosting or running a computer program can be configured to access, including signals downloaded through the Internet or other networks.

In various embodiments, the memory 204 may store an optimization manager 206 that may include computer-executable instructions or code to perform the techniques described herein. The optimization manager 206 may include various modules such as a parameter module 208, a data acquisition module 210, a cluster module 212, an optimization module 214, an analysis module 216, and/or a reporting module 218, among other possible modules. Each module is described in turn.

The parameter module 208 may identify various parameters associated with the cell sites. The parameters may include metrics, attributes, or other associated data for each cell site. Some of the parameters may be time-dependent, such as parameters that provide input/output data, service data, performance data (e.g., power use, dropped calls, etc.). Other parameters may not be time dependent, such as location information, hardware specifications, etc. The parameter module 208 may identify available parameters and, in some instances, identify parameters that impact, drive, or are associated with key result areas to enable optimization of the network performance. The parameter module 208 may receive user input, such as input from an administrator and/or engineer to assist in identification, labeling, or other tasks associated with the parameters.

The data acquisition module 210 may retrieve the parameters from various sources. For example, the data acquisition module 210 may link tables maintained and updated by various servers. The acquisition module 210 may compile the parameters over a predetermined period of time. The acquisition module 210 may perform basic operations on the obtained data, such as calculate an average, a mean, a maximum value, a minimum value, and/or perform other calculations using the obtained data.

The cluster module 212 may define a cluster based at least partly on the parameters received from the data acquisition module 210. For example, the cluster module 212 may identify key parameters that have associated conditions. Cell sites that include the key parameters that have satisfied the conditions (e.g., exceed a threshold value, below a threshold value, etc.) may be included (e.g., added, assigned, etc.) in the cluster. Thus, the cluster is defined by cell sites that include parameters having specific ranges of values. In some embodiments, the clusters are not defined solely on geographic region, but also include at least one operational parameter different than a geographic region.

The optimization module 214 determines one or more parameters to optimize (i.e., adjust) for each cluster. The optimization module 214 may optimize each cluster in different ways. For example, the optimization module 214 may increase a value or setting for a first parameter associated with a first cluster and may decrease a value or setting for a second parameter for a second cluster. In some embodiments, the optimization module 214 may make different adjustment based on the values of the parameters within a cluster. For example, a first range of cell sites in the first cluster may receive a first adjustment while a second range of cell sites in the first cluster may receive a second adjustment that is different than the first adjustment.

The analysis module 216 may analyze performance of the cell sites and/or the various components of the telecommunications network 100 following implementation of the optimization. In various embodiments, the analysis module 216 may initiate re-clustering of the cell sites, another optimization (via the optimization module 214), or other actions based on results of the analysis. For example, if performance of a cell site is degraded after the optimization, the cell site may be removed from the cluster, the cluster may be re-optimized, and/or the optimization manager 206 may take other actions.

The reporting module 218 may report results of the performance of the cell sites and/or the various components of the telecommunications network 100 following implementation of the optimization. The reporting module 218 may be used to trigger a subsequent refreshing of the optimizations, clustering, or other tasks performed by the optimization manage 206 in various times, such as periodically, at predetermined intervals, randomly, and so forth.

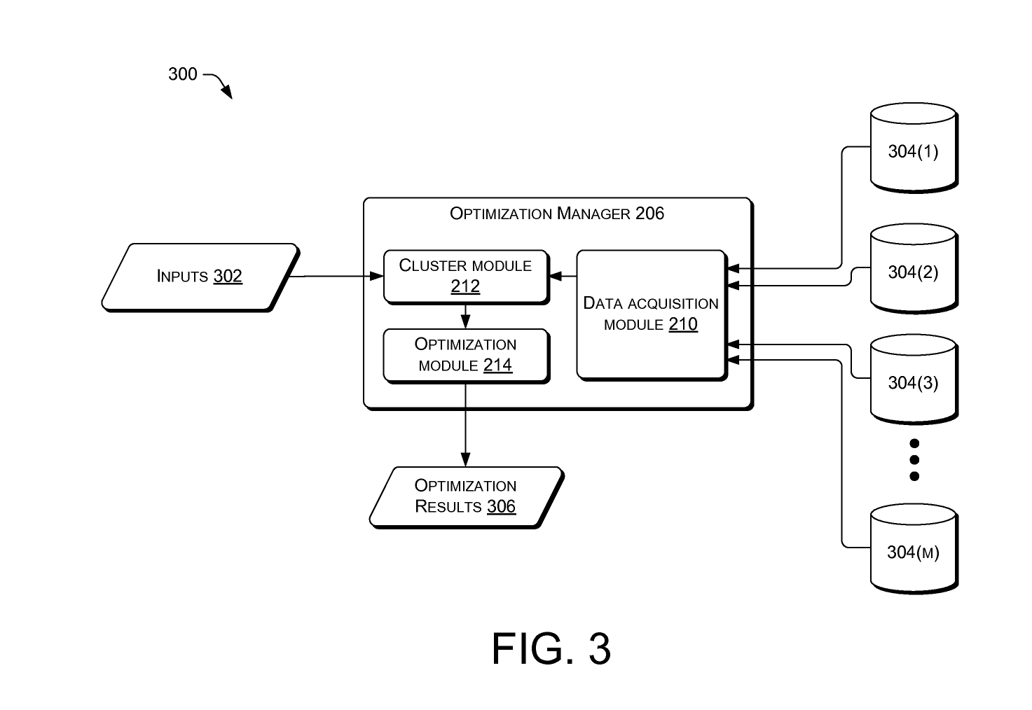

FIG. 3 is a schematic diagram of a computing architecture 300 to provide an automated clustering of the cell sites for optimization of a network. The architecture 300 may include the optimization manager 206. For illustrative purposes, the optimization manager 206 contains the data acquisition module 210, the cluster module 212, and the optimization module 214, although the optimization module may contain other modules or data.

In accordance with various embodiments, the data acquisition module 210 may extract data from various data sources 304(1), 304(2), . . . , 304(m). The data sources may include data related to hardware, services, or other related data. In some instances, the data may located in separate tables, locations, and/or may be controlled or managed by other entities. For example, the data may include customer survey information collected by a third party. The data acquisition module 210 may collect data from the various data sources 304(1), 304(2), . . . , 304(m) and provide the data to the cluster module 212 for association with respective cell sites. As discussed above, the data acquisition module 210 may perform some calculations of the data prior to providing the data to the clustering module 212.

In various embodiments, the cluster module 212 may receive the data from the data acquisition module 210 and inputs 302. The inputs 302 may include data associated with the cell sites such as, and without limitation, an area of the radio network controller, baseline dates (time period), metrics to optimize, thresholds for the metrics, and/or other associated data. In some embodiments, some or all of the inputs may be generated automatically and with no human input or with minimal human input. For example, a machine learning algorithm may be employed that uses heuristics to identify key metrics that have a strong correlation to key result indicators, such as available bandwidth, dropped calls, or other key result indicators. Thus, the inputs may be, at least in part, automatically machine-generated and provided to the clustering module 212 to enable the clustering module to create the clusters of the cell sites.

The optimization module 214 may receive data from the clustering module 212. The optimization module 214 may then perform the optimization to create optimization results, which may be deployed to the cell sites or other hardware in the telecommunications network 100. The optimization results 306 may include recommended parameter changes, implementation instructions, scripts to perform the changes, and/or other data to deploy the optimization for each of the cell sites.

In various embodiments, the optimization manager 206 may perform the operations described in FIG. 3 with little or no human input. The optimization manager 206 may re-optimize and/or re-cluster the cell sites after a predetermined amount of time after a last optimization is deployed, after predefined events, or based on other triggers. By automating some or all of the operations, the optimization manager 206 may dynamically manage the telecommunications network 100.

### Illustrative Operation

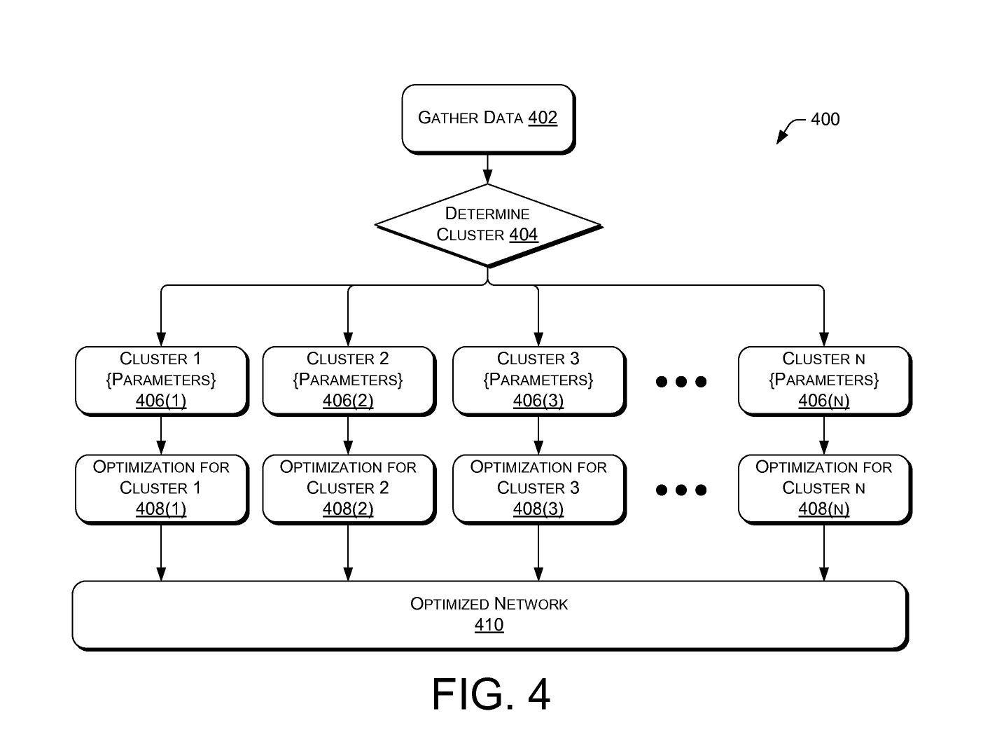

FIGS. 4-7 are flow diagrams of illustrative processes to optimize network performance using clusters of cell sites. The processes are illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 4 is a flow diagram of an illustrative process 400 to assign cell sites to clusters using parameters and then optimize some parameters to create an optimized network. The process 400 may be performed by the optimization manager 206 and various modules associated therewith.

At 402, the data acquisition module 210 may gather data (e.g., the parameters). In a basic implementation, the data may be gathered into a spreadsheet for manipulation by an administrator or engineer. In more advanced implementations, the data may be gathered into databases using queries, which may include automation by scripts, etc.

At 404, the clustering module 212 may determine the clusters using the data gathered at the operation 402. As discussed above, the clustering may be performed based on the inputs 302 and may employ some level of automation. In a basic implementation, the data may be sorted to identify cell sites having parameters that are capable of being optimized by adjustment of at least some of the parameters. The clusters may be identified as groupings of cell sites that have same or similar performance patterns based on the parameters (received data), rather than on arbitrary information such as geographical designation (e.g., city, rural, etc.) or other arbitrary information.

At 406(1), 406(2), . . . , 406(n), the cluster module 212 may create the clusters that include cell sites and the parameters for the respective cell sites. The number of clusters may depend on the complexity of the telecommunications network 100 (e.g., the number of cell sites, etc.), an amount of capital resources to manage the optimizations (e.g., availability of administrator(s) and engineers(s), etc.), and/or other relevant factors. The creation in the operation 406 may include assigning each of the cell sites to one or more of the clusters. In some embodiments, a cell site may fall within more than one cluster. This may be possible when the parameters being optimized do not conflict with one another. However, when the parameters conflict, the cell site may be assigned to one of the conflicting clusters and removed from the other cluster or clusters.

At 408(1), 408(2), . . . , 408(n), the optimization module 214 may create optimizations for each of the clusters. In some embodiments, the optimizations may include changes to one or more parameters of at least a portion of the cell sites in the cluster. For example, the cell sites within a cluster may be subdivided into additional groups. The optimization module 214 may provide a different change to the parameter or parameters for each group in the cluster when implementing the optimization for the cluster. In some instances, the optimization module 214 may use a same change to a parameter or parameters to implement the optimization. The optimization module 214 may thereby address the performance pattern of the cluster of the cell sites. In some embodiments, the optimization module 214 may ultimately achieve optimization of overall improvement at the cluster level, the RNC level, the market level, and so forth.

At 410, the optimization module may deploy the optimizations to the telecommunications network 410 which may result in an optimized telecommunications network.

Table 1 shows a list of possible clusters (via an arbitrary listing), each having an example condition, an example solution, and a possible optimization. More, fewer, or different clusters may be used in accordance with this disclosure.

TABLE 1

| | Example | | |
|---|---|---|---|
| No. | Condition | Example Solution | Possible Optimization |
| 1 | High Drops/Low | Increase minPwrMax by 3 dB | Reduced Drops/Increased |
| | DL Power Usage | | Power usage |
| 2 | High Drops/ | Increase minPwrMax by 2 dB | Reduced voice drops/slight |
| | Medium DL Power | | increased power usage |
| | Usage | | |
| 3 | High Drops/ | Increase minPwrMax by 1 dB/ | Reduced Drops/Maintained |
| | Medium to high DL | Increase pwrAdm by 5% | NAF/Increased Power |
| | Power Usage | | Usage |
| 4 | High Drops with | Reduce interPwrMax/ | Reduced Drops/Balanced |
| | DL Power | maxPwrMax. Increase | Power/Maintained or |
| | Congestion | minPwrMax by 1 dB. Check the | reduced DL Power Usage |
| | | Power Balance between carriers. | |
| | | Increase qRxLevMin/sRatSearch | |
| | | on overshooting cells | |
| 5 | Sites with DL | Reduce minPwrRI by 2 dB/ | Reduced DL Power Usage/ |
| | Power Congestion | Increase pwrAdm by 5%/Reduce | Balanced Power/Improved |
| | & Low Voice Drops | interPwrMax & maxPwrMax/ | Accessibility |
| | | Reduce CPICH Power on high | |
| | | CPICH Power % cells/Check | |
| | | Power Balance between carriers | |
| 6 | High NAF/High | Increase maxFach1Power/ | Reduced NAF/Reduced DL |
| | DL Power Usage | constantValueCprach. Reduce | Power Usage/Little to no |
| | but no DL Power | minPwrRI/interPwrMax/ | impact on drops |
| | congestion | maxPwrMax. Reduce CPICH on | |
| | | high CPICH Power % cells. Check | |
| | | power balancing between carriers. | |
| | | Increase qRxLevMin/sRatSearch | |
| | | on overshooting cells | |
| 7 | Cells with high | increase maxFach1Power/ | Improved Accessibility/ |
| | Voice NAF - Not | increase constantValueCprach | Slightly increased DL Power |
| | related to Capacity | | usage & UL RTWP |
| | issues AND Low | | |
| | DL Power Usage | | |
| 8 | High DCR & | Increase minPwrMax & | Improved Accessibility & |
| | NAF_No DL Power | maxFach1Power/Reduce | Retainability/Maintained or |
| | Congestion | interPwrMax & maxPwrMax if | reduced DL Power Usage |
| | | Power Usage is high/Reduce | |
| | | CPICH in overshooting and high | |
| | | CPICH power % cells | |
| 9 | High NAF/High | Increase DR to GSM | Reduced NAF/Impact on |
| | DL Power Usage/ | | 3G Leakage |
| | High TN | | |
| | Congestion | | |
| 10 | Low NAF/No | Reduce DR to GSM | Reduced 3G Leakage with |
| | Congestion issues | | little or no impact on NAF |
| 11 | High IRAT Rate/ | Reduce e2d triggers | Reduced IRAT Rate with |
| | Low Drops | | little impact on drops |
| 12 | Low IRAT Rate/ | Increase e2d triggers | Reduced drops with little |
| | High Drops | | impact on IRAT rate |
| 13 | Overshooting Cells/ | Negative individualOffset (up to −1 | Traffic moved away from the |
| | Low to Normal | dB) | source cell/Reduced |
| | CPICH Power/ | | congestion/Reduced SHO |
| | Congestion/High | | |
| | SHO Overhead | | |
| 14 | Undershooting | Positive individualOffset (up to 2 | Source cell takes more traffic - |
| | Cells/No | dB) | well utilized/Increased |
| | Congestion/Low | | SHO |
| | Traffic Cells/Low | | |
| | SHO Overhead | | |
| 15 | Cells with High DL | Reduce minPwrMax/Reduce | Reduced Power Usage/ |
| | Power Usage | CPICH (if in high CPICH group)/−ve | Traffic Balancing from high |
| | | individual offset | power cells to low power |
| | | | cells/Improved Accessibility/ |
| | | | Little to no impact on |
| | | | retainability |
| 16 | Cells with Low DL | +ve individual Offset/+ve | Traffic Balancing from high |
| | Power Usage | qOffset2sn/increase minPwrMax/ | power cells to low power |
| | | increase CPICH if it is in low | cells/improved retainability/ |
| | | CPICH group/increase | little to no impact on |
| | | maxFach1Power for accessibility | accessibility/incresaed |
| | | | power usage |
| 17 | Imbalanced traffic | Increase sInterSearch trigger to | Better traffic balancing |
| | between carriers in | move traffic away/Reduce | |
| | a sector | sInterSearch trigger to keep traffic | |
| | | in OR Match sInterSearch, | |
| | | loadSharingMargin | |
| 18 | High Drops/High | Reduce CPICH (value depend on | Reduced Overshooting, pilot |
| | DL Power Usage/ | CPICH based group classification)/ | pollution/Reduced Drops |
| | Overshooting/ | increase minPwrMax up to 1 dB | due to pilot pollution and |
| | (Cells may also | | edge coverage issues/ |
| | have good RSCP | | Reduced power |
| | but bad EcNo | | |
| | [WMRR]) | | |
| 19 | High Drops/Low | Increase CPICH (value depend on | Improved in building |
| | or Medium DL | CPICH based group classification)/ | coverage/Reduced drops/ |
| | Power Usage/No | increase minPwMax up to 1 or 2 | Increased Power Usage |
| | Overshooting | dB | |
| 20 | Cells with high Idle | Reduce sHcsRat up to 0. Also | Reduced Idle Mode Leakage |
| | mode leakage, but | reduce fddRscpMin/fddQMin with | with little to no impact on |
| | qRxLevMin can | COEXUMTS set to 2 on | accessibility/retainability |
| | not be reduced | underlying 2G cells | |
| | due to accessibility | | |
| | issues. And | | |
| | sRatSearch is | | |
| | already at zero | | |

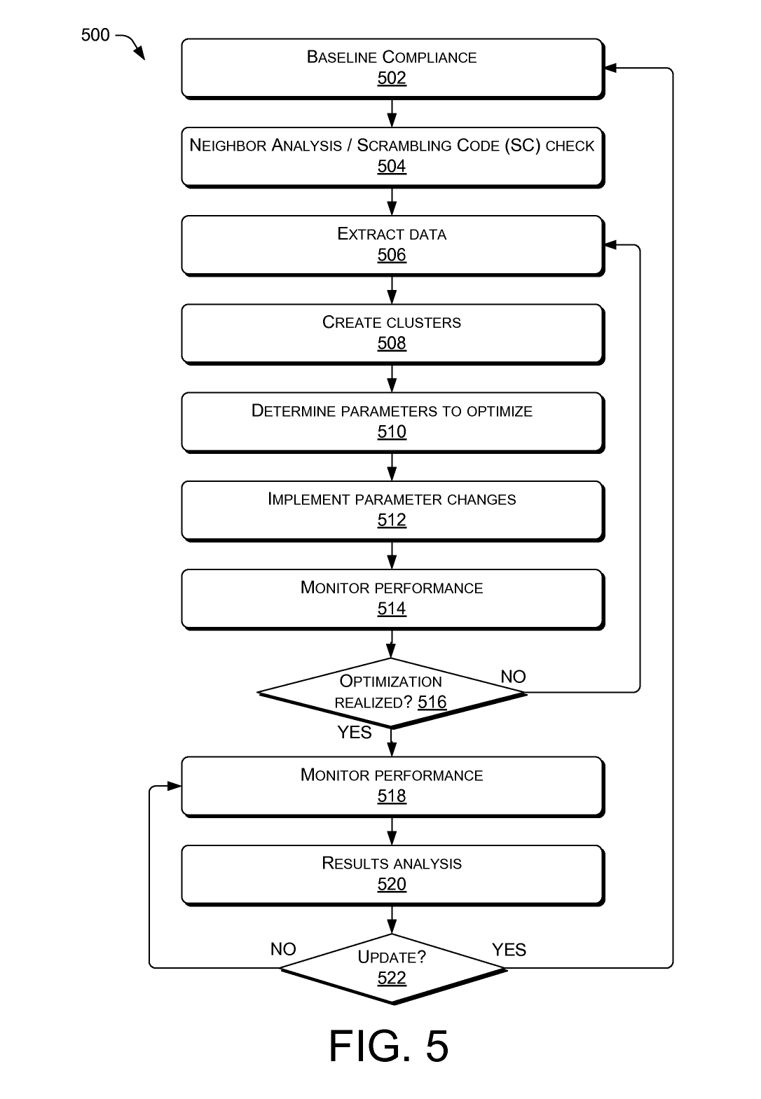

FIG. 5 is a flow diagram of an illustrative process 500 to assign cell sites to clusters using an iterative approach using parameters and then optimize some parameters to create an optimized network. The process 500 may be performed by the optimization manager 206 and various modules associated therewith.

At 502, the optimization manager 206 may perform a baseline compliance analysis of the cell sites to ensure the cell sites are operating in accordance with predetermined standards and baseline values. When cell sites are identified that are not compliant, the cell sites may undergo maintenance. The non-compliant cell sites may or may not be excluded from the optimization depending on various factors, such as whether the cell sites have “clean” data that accurately represents performance of the cell site, and so forth.

At 504, the optimization manager 206 may perform a neighbor analysis and/or a scrambling code (SC) check.

At 506, the data acquisition module 210 may extract data from data sources to obtain parameters determined by the parameter module 208. For example, the parameter module 208 may determine parameters that are relevant to the cell sites, which may or may not be based on user input. The data acquisition module 210 may then extract the data for a predetermined period of time for each of the cell sites (while possibly excluding non-compliant cell sites or other cell sites that do not have valid data). Non-time dependent data may also be extracted for each cell site.

At 508, the cluster module 212 may create the clusters of the cell sites using the data from the operation 506. For example, the cluster module 212 may query the data to select cell sites having parameters that meet predetermined criteria. In some embodiments, the cluster module 212 may include an iterative process that includes multiple steps to select the cell sites via a querying or sorting process.

At 510, the optimization module 214 may determine the parameters to optimize for each cluster. The optimization module 214 may or may not receive user input to determine the optimization parameters and corresponding changes. For example, the optimization module 214 may perform heuristics to determine parameters that may be adjusted or changed to improve performance of the cell sites in the respective cluster. In some embodiments, the optimization module 214 may employ micro-adjustments to the cell sites in a cluster or may make adjustments to a sample group of cell sites in the cluster to determine optimum changes to parameters of the cell sites in the cluster using an iterative process.

At 512, the optimization module 214 may implement the parameter changes. For example, the optimization module 214 may deploy changes to the cell sites in a cluster to implement the changes or adjustments to the parameters determined at the operation 510.

At 514, the analysis module 216 may monitor the performance of the cell sites. The analysis module 216 may track specific parameters, including parameters related to the parameters that were adjusted in the operation 512. Thus, the analysis module 216 may determine an effect of the changes.

At 516, the analysis module 216 may determine whether an optimization is realized after implementation of the changes from the operation 512 based on the monitoring at the operation 514. For example, the analysis module 216 may compare the monitored parameters to threshold values, what when reached or exceeded, indicate that the cell sites of the cluster has realized the optimization or not realized the optimization. The analysis module 216 may perform the inquiry at 516 within, at, or after a threshold amount of time after implementing the change. When the optimization is not realized (e.g., threshold values are not reached, etc.), then the process 500 may return to the operation 506 (via the “no” route from the decision operation 516). In some embodiments, the operation 516 may return to other operations in the process 500 when following the “no” route from the decision operation 516, such as to the operation 508 to recreate the clusters, to the operation 510 to determine new parameters to optimize, and so forth.

When the optimization is realized (following the “yes” route from the decision operation 516), then the process 500 may advance to an operation 518. At 518, the analysis module may continue to monitor performance of the cell sites of the clusters. At 520, the reporting module 218 may provide reports and/or report data to one or more of the various data sources (e.g., 304(1)-304(M)) to enable baseline performance comparisons, optimization tracking, and so forth. The results analysis may use the data collected by the monitoring at the operation 518.

At 522, the analysis module 216 may determine whether to update the optimization, clustering, or other tasks in the process 500, such as to refresh the optimizations after a passage of time, after an event, and/or after another trigger. In some instances, the passage of time may be longer than a threshold amount of time used in determining whether the optimization is realized in the decision operation 516. The updates may be contingent on available resources (e.g., review by administrator or engineer, computing resources, etc.), based on a fixed schedule, performed periodically, performed randomly, etc. When the analysis module 216 determines to perform an update (following the “yes” route from the decision operation 522), then the process 500 may advance to the operation 502 or another operation in the process 500. When the analysis module 216 determines not to perform an update (following the “no” route from the decision operation 522), then the process 500 may advance the operation 518 and continue to monitor performance of the cell sites of the clusters.

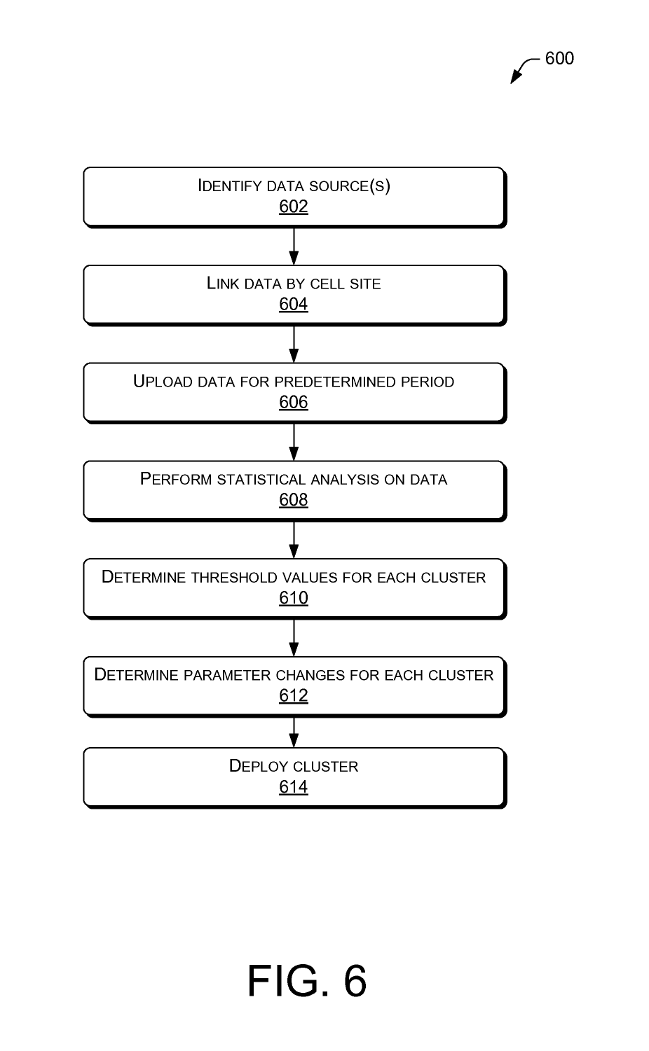

FIG. 6 is a flow diagram of an illustrative process 600 to create one or more clusters and at least one parameter to optimize each cluster. The process 600 may be performed by the optimization manager 206 and various modules associated therewith.

At 602, the optimization manager 206 may identify data sources (e.g., the data sources 304) that have data that is relevant to each of the cell sites. The identification may be performed at least partially by user input, such as by user selection of relevant data sources, by mapping of the sources, and so forth.

At 604, the data acquisition module 210 may link data from the data sources. The data may be linked to enable acquisition of data for each cell site, such as by creating a script that automatically extracts data for each cell site across a plurality of databases, tables, and/or data sources.

At 606, the data acquisition module 210 may upload or update data for a predetermined period or amount of time. For example, the data may be for predetermined number of seconds, minutes, hours, or days. In some embodiments, the data acquisition module may perform some calculations on the data, such as to create averages, maximum values, minimum values, and so forth.

At 608, the data acquisition module 210 may perform statistical analysis on the data. The statistical analysis may determine trends in the data, which may be related to key performance indicators and/or parameters that may be adjusted to create an optimization.

At 610, the cluster module 212 may determine threshold values for each cluster using the statistical analysis data from the operation 608. The threshold values, or conditions, may be used to select the cell sites for the particular cluster. For example, a first cluster may include threshold values that relate to an amount of power transmitted by a cell site and/or other metrics.

At 612, the optimization module 214 may determine parameter changes for each cluster. As discussed above, the optimization module 214 may determine different adjustments for the cell sites in a cluster based on different ranges of values of the parameters. Thus, the optimization module 214 may not make the same change to all the cell sites in a cluster, but may vary an approach based on a stepwise function, a linear function, or other types of functions.

At 614, the optimization module may deploy the optimization of the cluster. The deployment may implement the changes to the cell sites included in the cluster or clusters, and thereby optimize performance of the network.

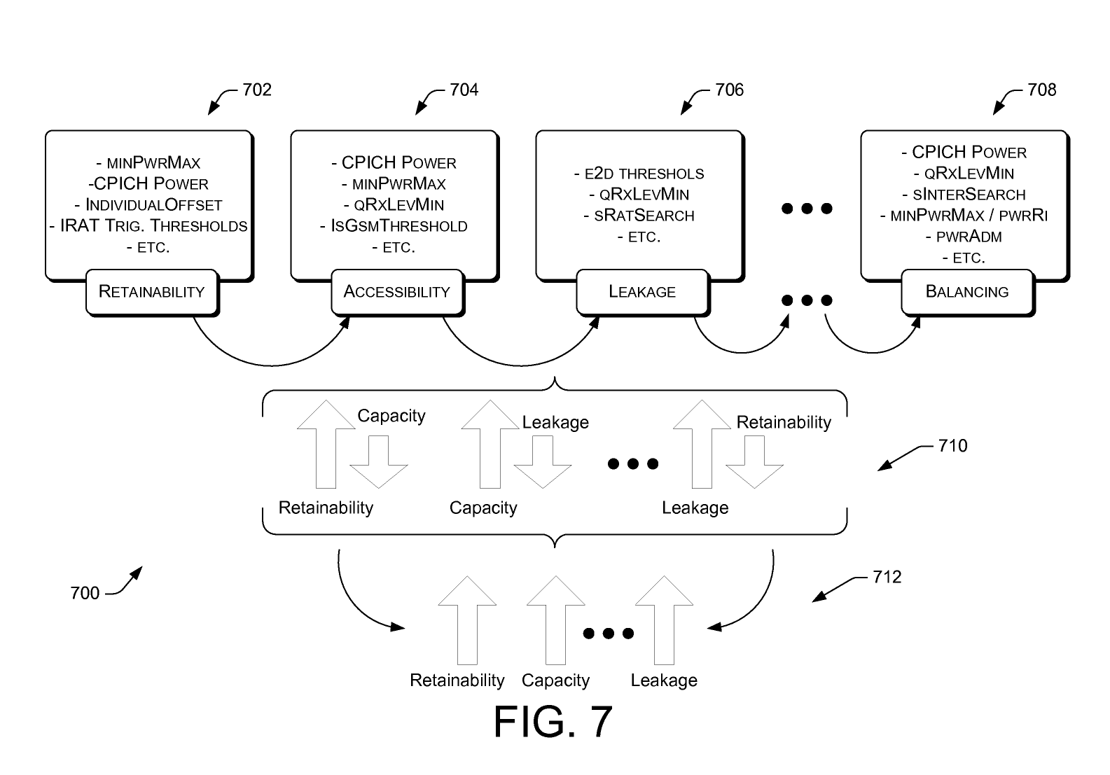

FIG. 7 is schematic diagram showing an iterative process 700 to customize parameter changes for various clusters to optimize network performance. The iterative process 700 may be performed by the optimization manager 206 and various modules associated therewith. The iterative process 700 may be performed within the framework of the process 500 or any of the other processes described herein. For example, the process 700 may be performed by the optimization module 214 between at least the operations 512 and 516 in the process 500.

At 702, the optimization module 214 may determine various parameters and parameter changes to be implemented for a cluster to optimize an aspect of the cell sites in the cluster. For example, at 702, the optimization module 214 may optimize an aspect of retainability for connections between user devices (e.g., mobile telecommunications devices, etc.) and the cell sites. At 704, the optimization module 214 may determine the same or other parameters that may be modified to optimize another aspect of the cell sites in the cluster. For example, the optimization module 214 may optimize the parameters to achieve accessibility. At 706 the optimization module 214 may optimize parameters to lower leakage. At 708, the optimization module 214 may optimize parameters to enable traffic balancing, and so forth.

As shown at 710, each optimization cycle may result in an optimized aspect (represented by an upward arrow) and a degraded aspect (represented by a downward arrow). For example, optimization of retainability may result in a degradation of capacity for a network. An optimization of capacity may result in a degradation of leakage and an optimization of leakage may result in a degradation of retainability, and so forth. Ultimately, the optimizations may outweigh the degradations, which may result in a global improvement in operational performance of the cluster of cell sites and for the telecommunications network 100 as a whole, as shown at 712. Thus, the optimization module 214 (and possibly other modules in the optimization manager) may employ an iterative approach to reach an optimization of the clusters and of the telecommunications network as a whole.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
receiving metrics from a plurality of cells sites that exchange data with mobile telecommunication devices in a telecommunications network, the metrics related to performance operations of the cell sites with respect to time;
grouping the cell sites into a plurality of clusters based at least in part on the metrics, at least one of the clusters being associated with multiple ones of the metrics;
determining at least one parameter that, when adjusted, optimizes one of the metrics for at least a portion of the cell sites in one of the plurality of clusters;
implementing a change to the at least one parameter to optimize performance of the at least the portion of the cell sites in the one of the plurality of clusters; and
repeating the grouping, the determining, and the implementing, wherein the repeating of the grouping includes grouping at least one of the cell sites into a different cluster.

2. The method as recited in claim 1, wherein the grouping of the cell sites, the determining the at least one parameter, and the implementing the change is performed as an iterative process.

3. The method as recited in claim 1, wherein the determining at least one parameter includes:
determining a first parameter change for a first portion of the cell sites in the one of the plurality of clusters; and
determining a second parameter change different than the first parameter change for a second portion of the cell sites different than the first portion in the one of the plurality of clusters.

4. The method as recited in claim 1, further comprising, prior to the receiving the metrics:
determining a baseline compliance for the cell sites; and
performing a neighbor analysis and scrambling code check for the cell sites.

5. The method as recited in claim 1, further comprising:
monitoring performance of the at least the portion of the cell sites in the one of the plurality of clusters to determine whether an optimization is realized; and
when the optimization is not realized, performing the repeating.

6. The method as recited in claim 5, wherein the monitoring is performed for a threshold amount of time after the implementing of the change.

7. The method as recited in claim 6, further comprising when the optimization is realized, performing the repeating after a triggering event that occurs after the threshold amount of time.

8. The method as recited in claim 1, wherein the cell sites are base stations in the telecommunication network.

9. The method as recited in claim 1, wherein the determining the at least one parameter to optimize is performed using heuristics to identify the change to implement for the at least the portion of the cell sites in the one of the plurality of clusters.

10. The method as recited in claim 9, wherein the heuristics are performed using a sample set of the cell sites or incremental changes to the at least one parameter.

11. One or more computer-readable media storing computer-executable instructions that, when executed on one or more processors, performs acts comprising:
receiving metrics from cells sites that exchange data with mobile telecommunication devices in a telecommunications network;
clustering the cell sites into a plurality of clusters based at least in part on the metrics, at least one of the clusters being associated with multiple ones of the metrics;
implementing a change to at least one parameter associated with the metrics for each cluster to optimize performance of the respective cluster of the cell sites, the at least one parameter being different across at least two of the plurality of clusters; and
repeating the grouping, the determining, and the implementing, wherein the repeating of the grouping includes grouping at least one of the cell sites into a different cluster.

12. The one or more computer-readable media as recited in claim 11, wherein the metrics are related to performance operations of the cell sites with respect to time.

13. The one or more computer-readable media as recited in claim 11, wherein values of the parameter for each cluster include at least one of a step-wise function or a linear function to implement the change.

14. The one or more computer-readable media as recited in claim 11, further comprising:
monitoring performance of each cluster to determine whether an optimization is realized; and
when the optimization is not realized, performing the repeating.

15. The one or more computer-readable media as recited in claim 11, further comprising determining the at least one parameter to optimize using heuristics.

16. A telecommunications system comprising:
one or more processors;
memory to store computer-executable instructions executable by the one or more processors;
a data acquisition module stored in the memory and executable by the one or more processors to acquire metrics from cell sites;
a clustering module stored in the memory and executable by the one or more processors to cluster the cell sites into a plurality of clusters based at least in part on the metrics, at least one of the clusters being associated with multiple ones of the metrics; and
an optimization module stored in the memory and executable by the one or more processors to adjust parameters of the plurality of clusters including a first parameter associated with the metrics to optimize performance a first cluster of the plurality of clusters and a second parameter associated with the metrics to optimize performance a second cluster of the plurality of clusters; and
an analysis module stored in the memory and executable by the one or more processors to repeat the clustering and the adjusting, wherein the repeating of the clustering includes clustering at least one of the cell sites into a different cluster.

17. The system as recited in claim 16, wherein the analysis module is further to:
analyze performance of the clusters after the adjustment of the parameters; and
initiate the repeating when the performance indicates that an optimization is not realized for the at least one cluster.

18. The system as recited in claim 16, wherein the optimization module adjusts the parameters using an iterative process.

19. The system as recited in claim 16, wherein the metrics are related to performance operations of the cell sites with respect to time.

20. The system as recited in claim 16, wherein the cells sites are base stations that exchange data with mobile telecommunication devices in a telecommunications network.
